(19) United States
(12) Patent Application Publication
(10) Pub. No.: US 2008/0199242 A1
(43) Pub. Date: Aug. 21, 2008

(54) Printer Protective Cover with Integrated Message Display

(76) Inventor: Gary Knight, Woodruff, SC (US)

Correspondence Address: John B. Hardaway III;Nexsen Pruet, LLC, P.O. Box 10648, Greenville, SC, 29601, US

(21) Appl. No.: 11/958,003

(22) Filed: Dec. 17, 2007

Related U.S. Application Data
(60) Provisional application No. 60/875,321, filed on Dec. 15, 2006.

(51) Int. Cl. B41J 29/13

(52) U.S. Cl. 400/693

(57) ABSTRACT

The invention is a protective cover for a point-of-sale receipt printer which protects the printer from damage caused by dropping coins into the printer as change is made for purchases. The cover has a base to make a snap-on attachment to a printer, a front arm to deflect coins away from a paper guide which directs the receipt away from the discharge point of the printer enclosure and a display portion to show promotional messages to the customers.

### BACKGROUND OF THE INVENTION

This invention is directed to protecting point-of-sale printers by providing a printer cover device more particularly to a device that helps keeps foreign objects from getting inside the printer while providing a display portion for inserting business cards that display promotional or informational messages for the customers and the cashier.

Accordingly, an object of the present invention is to provide a printer cover device to keep foreign objects from falling into openings in the top of a point-of-sale printer causing damage to the printer.

An essential object of the present invention is to provide a plurality of dams and a paper guide on the printer cover device that help to block the entry of foreign objects inside the printer.

A further object of the present invention is to provide a printer cover device that is easily installed and supported on the printer that can remain on the printer without impeding normal operation of the printer.

Another object of the present invention is to provide a display portion built integral with and as a part of the printer cover device for displaying information to the point-of-sale customer and the cashier.

Yet another object of the present invention is to provide the information on card stock that can be inserted in card slots of the display portion. The information can be operational or management instructions for a cashier and/or promotional and informational messages for the store customers.

Still another object of the present invention is to provide protective covers to keep information cards made from the card stock from being damaged and to provide for easy reading of the information.

One additional object of the present invention is to provide for easy removal and changing of the information cards in the display portion without removing the cover from the printer; thus eliminating the potential for the loss or misplacement of the cover device and the loss of benefits provided by the device

### DEFINITION OF TERMS

The following terms are defined herein to provide a basis for the discussion of the invention and the claims.

Device: A printer protective cover base including an A-frame display portion and a paper guide assembly.
Base Fit: The device conforms to the top exterior shape of the printer thus providing a glove like fit. This fit makes the presence of the device unobtrusive and visually pleasing.
Retention Mechanism: Inside edge of device sides (lips) are formed at a negative draft angle providing sufficient pressure to retain device on printer without the need for some form of adhesive.
Retention Tape: The device allows for the use of double sided tape to more permanently attach the device to the printer. Optional recessed circles on the bottom side of the base portion of the device denotes areas to attach the double sided tape.
Polycarbonate: The material used to manufacture the device to provide the strength and durability required by retailers; commonly known as retail hardening.
Functional Printer: All original functionality of the printer remains unimpeded by the device. The device uses apertures which provide access to paper advance and cutoff buttons. Access to interior of printer to change paper and access the print head is maintained as the device remains attached to the top of the printer as it is opened to provide the access.
Dams: The Device incorporates two barriers (front and rear dams) that are specifically positioned to reduce the potential for foreign objects to fall into the interior of the printer where they very often will short circuit the electronics causing failure of the printer.
Paper Guide Portion: A guide for receipt paper which serves to both prevent entry of foreign objects such as coins into the printer and guide the receipt paper in the direction of the cashier.
Tear Bar The rear dam of the paper guide assembly acts as a tear bar when cashiers manually tear off a receipt instead of allowing the printer functions to effect tearing.
A-frame Display Portion; The device incorporates a marketing and messaging capability. Standard business card slots permit the strategic placement of promotional, instructional or advisory messages. Such messages can be directed toward both the customer and the cashier. Such messages can enhance the relationship between retailer and customer. Additionally they can promote actions on the part of cashier which can reduce theft and address other operational issues and concerns experienced by retailers. The A-Frame is one design for displaying such messages. Other designs are within the scope of this invention.
Card Stock: Business or information cards are inserted in the A-frame of the device to provide promotional or informational messages to the customer and/or operational messages for the cashier.
Protective Covers: The card stock is inserted under the protective covers of the A-frame, thus eliminating soiling, tearing and reducing the likelihood of unauthorized removal. The device is designed and manufactured using etching techniques which reduce the effects of glare from overhead store lighting.
Thumb or Pencil Slots: The device incorporates cutouts which facilitate the removal/replacement of the card stock without detaching the device from the printer. A person's finger or an instrument such as a pencil can be utilized to remove the card stock from the device.
Retaining Ledges: The A-frame incorporates portions to guide insertion, to provide retention and help in removing card stock. Ledges further serve to reduce the potential of foreign objects entering the printer through the slots.
Custom Logo Area: The device is provided with a location for a custom store logo or other message. The logo or message area is highly polished in order to be visually eye catching.

### SUMMARY OF THE INVENTION

The above objectives are accomplished according to the present invention by providing a combination protective cover for a conventional point-of-sale receipt printer to keep foreign objects from getting inside the printer system and providing a general information display portion as a part of the protective cover. The protective cover comprises a base having two side lips and a rear lip to grip three sides of the printer and conform to the exterior shape of the printer and provide a glove-like fit. Front and rear dams extend above the top surface of the base and helps keep foreign objects from falling into the printer system and adjacent equipment. A paper slot with a paper guide above the paper slot also deflects foreign objects from getting into the printer system while allowing receipt paper to be discharged from the printer through the paper slot. The information display portion comprises an A-frame display portion having card slots to receive information cards. The display portion includes front and rear protective covers for the card stock.

The invention further includes the base having a pair of printer access cutouts and a printer recess to provide unobstructed use of the operational buttons and access to the printer system. The base also includes a printer clearance portion to allow the base to conform to a top surface of the printer. A retention latch extending from a bottom edge of one of the two side lips engages a top of the printer and helps to hold the base attached to the printer.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a perspective view of a printer cover device including a base, an A-frame display portion and a paper guide assembly, where the device is depicted as being installed on a conventional point-of-sale receipt printer system including a check endorser;

FIG. 2 is an enlarged perspective view of the printer cover device of the present invention;

FIG. 3 is a top plan view of the printer cover device of the present invention of FIG. 2;

FIG. 4 is a bottom view of the printer cover device of the present invention of FIG. 2;

FIG. 5A is a left side elevation view of the printer cover device of the present invention of FIG. 2;

FIG. 5 B is a right side elevation view of the printer cover device of the present invention of FIG. 2;

FIG. 6 is a cross-sectional view of the printer cover device taken along line A-A in FIG. 3;

FIG. 7 is a cross-sectional view of the printer cover device taken along line B-B in FIG. 3;

FIG. 8 is an enlarge perspective view showing the paper guide assembly area of the present invention of FIG. 2;

FIG. 9 is an enlarged perspective view showing the front dam area of the present invention of FIG. 2; and

FIG. 10 is an enlarged perspective view of a partial A-frame portion of the printer cover device showing two card stocks positioned for insertion under A-frame protective covers.

### DESCRIPTION OF A PREFERRED EMBODIMENT

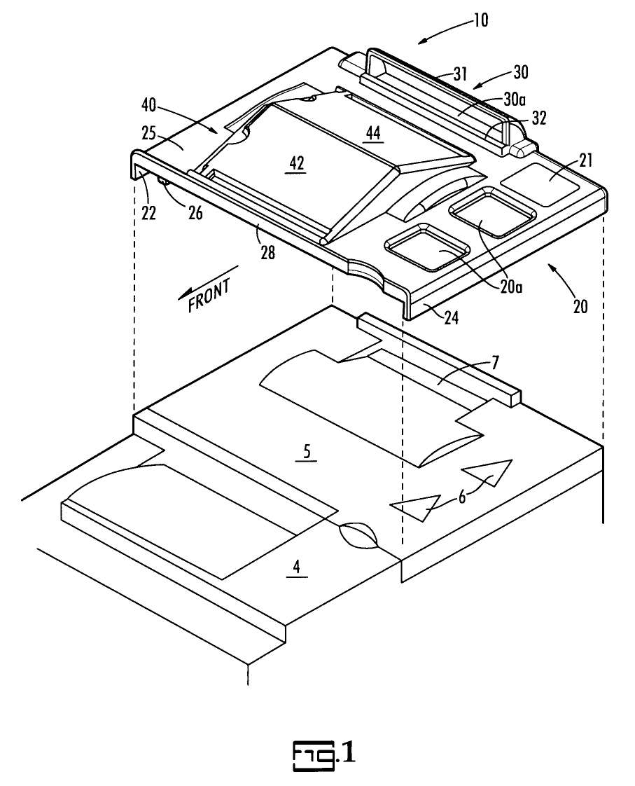

Referring now in more detail to the drawings, the invention will now be described in more detail. The invention provides a printer cover device 10 to cover and protect a conventional point-of-sale printer 5 as illustrated in FIG. 1. The essential components of the device include a base 20 that fits on a printer 5 and grips the top of the printer with a glove-like fit with side lips 22 and 24, a rear lip 23 (not shown) and a side latch 26. Access to printer buttons 6 by a cashier is provided by printer button access cutouts 20a and 20b. Receipt paper is discharged from the discharge slot 7 of the printer. However, a problem exists when foreign objects enter the printer through the discharge slot potentially causing damage or malfunction. One important function of the printer cover device is to help keep foreign objects from getting inside the printer by providing a paper guide portion 30. The paper guide portion has paper guide 31 which covers a paper slot 30a in the base and directs the receipt paper to a cashier. The paper guide portion also includes a rear dam 32 to keep foreign objects from sliding into the paper slot from the base top 23. In addition, adjacent to and in front of the printer is a check endorser 4 where a customer check is placed to enter the endorser become endorsed and discharged from the check endorser. To prevent foreign objects from entering the check endorser from cover device 10, a front dam 28 is also placed along the front edge of base 20.

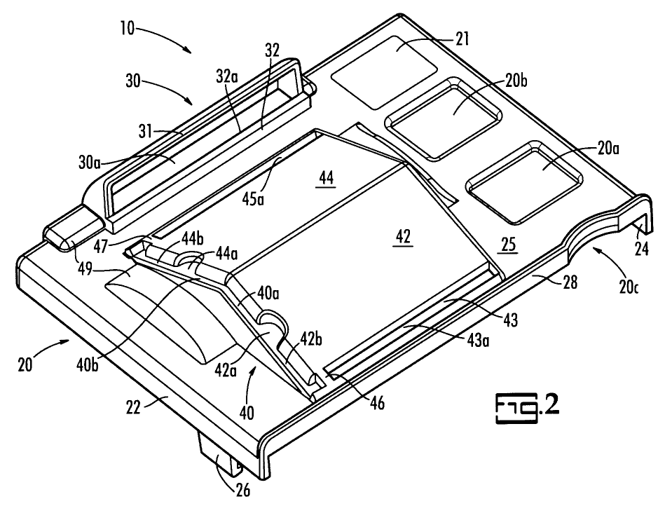

An added feature of the printer cover device is an A-frame display portion 40. The display portion utilizes space available on the top of the base for displaying information for the cashier as well as a customer. For the purpose of this discussion the front of printer cover device 10 is directed toward the cashier. The information may be operational instructions for the cashier or may be promotional and informational messages for the customer to read. The information is printed on information cards (see FIG. 10). Information for the cashier is positioned behind a front protective cover 42 and information for the customer is placed behind the rear protective cover 44. The A-frame display portion is discussed in more detail in the later description of FIGS. 2, 3 and 10.

The printer cover device is discussed in more detail by referring to the large scale perspective of FIG. 2. Once again base 20 has side lips 22 and 24 that grip the top edge of the printer and printer button access cutouts provide access to printer buttons. A printer cover recess 20c is also necessary to provide access to the check endorser. The cover device stays on the top of the printer when the printer is opened. A logo area 21 on base top 25 is identified for adding a manufacturers logo or one for the store. Paper guide portion 30 with paper slot 30a, paper guide 31 and rear dam 32 was discussed above. However, the rear dam also provides a tear edge 32a used to provide a sharp edge for tearing off the receipt paper if the printer tear button is not used.

Additional details of A-frame display portion 40 are shown in the perspective views of FIG. 2 and FIG. 10. The illustration of FIG. 10 shows the two information cards in position to be placed in the display portion. Generally speaking, the card sloped toward the front is an instructional message card 50 to be read by the cashier. It may contain operational information, sale data for the cashier to inform the customer about, safety and security procedures and the like. The card sloped toward the rear (toward the customer) is generally speaking a promotional message card 52. This card may advertise merchandise, announce store events, give checkout instructions and the like. Informational message card 50 is placed in card slot 40a below front protective cover 42 and above a side card ledge 42b. Promotional message card 52 is placed in card slot 40b below rear protective cover 44 and above side card ledge 44b. The protective covers protect the promotional or information message cards from damage and customer removal. The protective covers have highly polished and etched surfaces to provide unobstructed viewing of the information and reduce glare from the overhead lighting. Card removal slots 43a and 45a are provided on a bottom lateral side of front protective cover 42 and rear protective cover 44 respectively. Thumb slot 42a is provided in the front protective cover and thumb slot 44a is provided in the rear protective cover. These slots are used to access the promotional and informational message cards for removal and replacement.

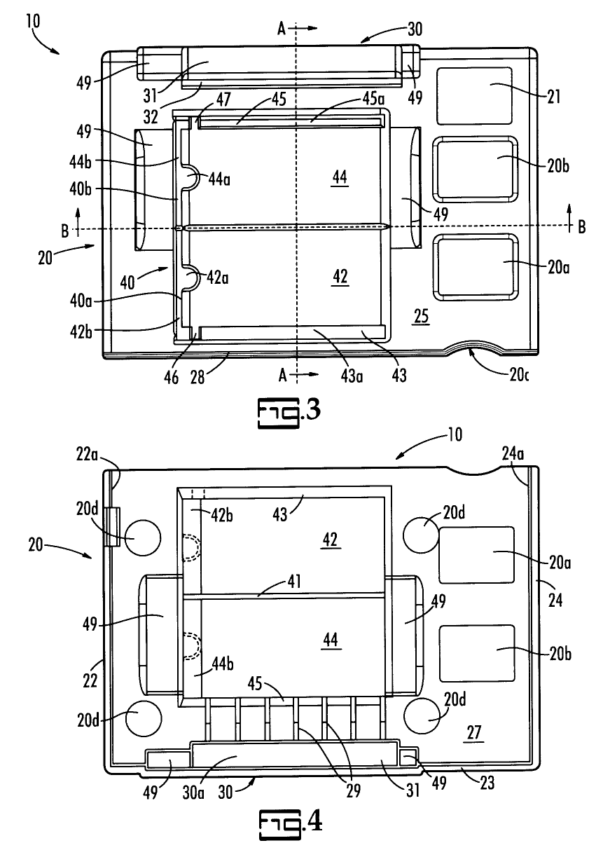

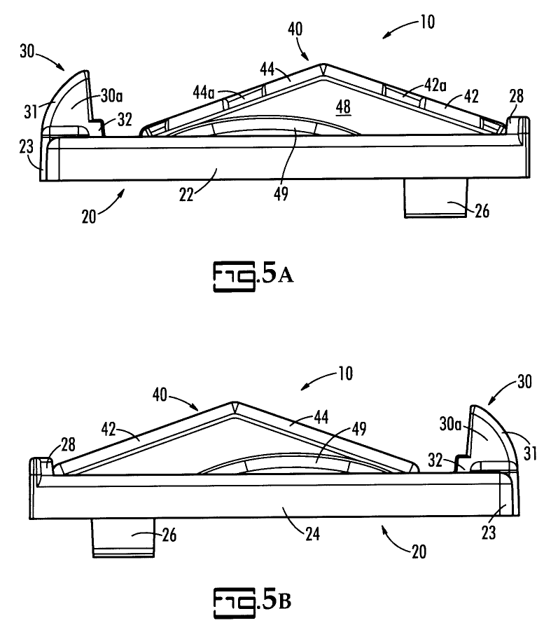

Additional details of the printer cover device are shown in the top view of FIG. 3 and the bottom view of FIG. 4. For example printer clearance portions 49 are identified in four locations in FIG. 3. The printer clearance portions are necessary to provide contact between base bottom 27 and the top surface of printer 5. With the contact being realized, another embodiment of the invention is realized. A double sided tape can be used to provide a more permanent attachment of the cover device to the printer. Four optional circular recess areas 20d are identified on the base bottom of base 20, as shown in FIG. 4. The double sided tape is placed in the recess areas to contact the printer when the cover device is placed on the printer and pressure is applied to form an attachment.

Recess areas can have other shapes such as square or rectangular. Positive attachment is also provided by retention edges 22a, 24a and 23a of side lips 22 and 24 as well as rear lip 23 respectively. These retention edges provide the glove-like fit of the cover device on the printer. Another embodiment of the invention includes reinforcing members 29. These members are added to strengthen base 20 between A-frame display portion 40 and paper guide portion 30.

Side views 5A and 5B illustrate the relationship between different components of the printer cover device from the left side and the right side respectively. Many of the same components as identified above are again shown in these views. However, both side walls 48 are better illustrated in these side views. In addition, there is a latch 26 on the left side of base 20 (FIG. 5A) attached to the bottom edge of side lip 22. The latch engages a recess in the side of the printer to help hold printer cover device 10 attached to printer 5. With the latch the circular recesses and the double sided tape on base bottom 27 are generally not required. This feature is considered to be an alternate embodiment of the invention.

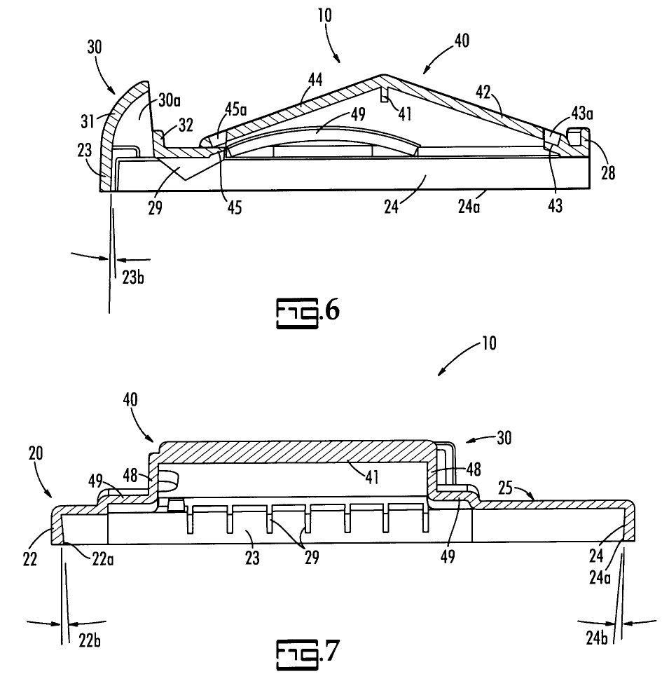

The cross-sectional view of FIG. 6 is taken along line A-A of FIG. 3. This view shows additional features of base 20 and A-frame display portion 40 not illustrated in other views. Front card ledge 43 extends from the base to support a lower edge of the front instructional message card 50 when the instructional message card is inserted in front card slot 40a (see FIG. 10). A ridge card retainer 41, placed between front protective cover 42 and rear protective cover 44, supports an upper edge of instructional message card 50 when the instructional card is in place below the front protective cover. The front card ledge also keeps foreign objects from falling through front card removal slot 43a. Rear card ledge 45 extends from the base to support a lower rear edge of promotional message card 52 when the card is inserted in front card slot 40b (see FIG. 10). Once again, ridge card retainer 41 supports an upper edge of promotional message card 52 when the promotional message card is in place below the rear protective cover. The rear card ledge also keeps foreign objects from falling through rear card removal slot 45a. Another feature, illustrated in FIG. 6, is the presence of a negative draft angle 23b in rear lip 23. This negative draft angle helps printer cover device 10 remain attached to the printer In addition, the configuration of reinforcing member 29 is best illustrated in FIG. 6.

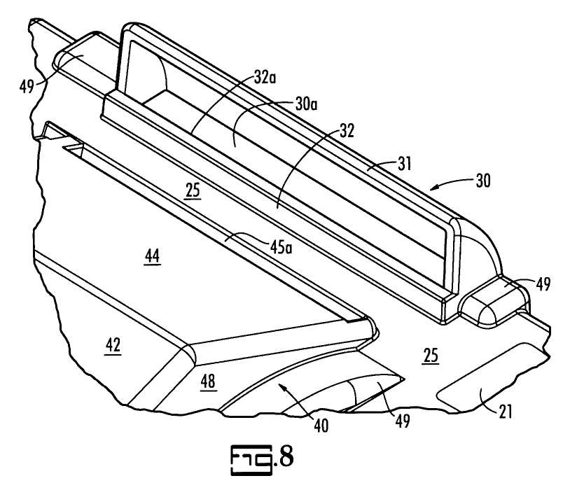

The cross-sectional view of FIG. 7 is taken along line B-B of FIG. 3. The configuration of certain features are also best illustrated in this figure. The 7 reinforcing members 29 are again located in this figure. The section is also taken through upper card ledge 41 to show the vertical extent of this feature. Both side lips are shown with draft angles to help hold printer cover device 10 on the printer.

A left draft angle 22b of left lip 22 is provided so that left retention edge 22a provides pressure on the top of the printer. A right draft angle 24b of right lip 24 is provided so that the right retention edge 24a also provides pressure on the top of the printer. The combination of pressure provided by lips 22, 23 and 24 provides a glove-like fit of the cover device on the printer.

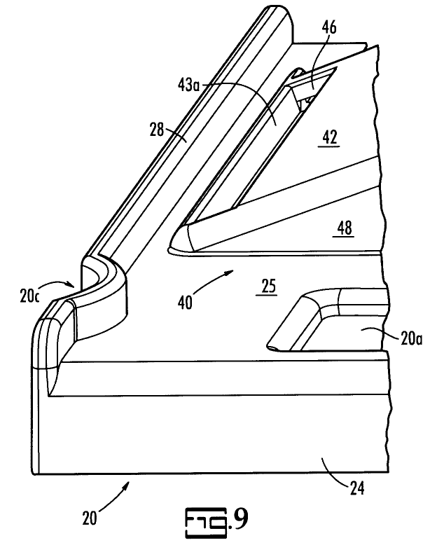

An enlarged view of paper guide assembly 30 and the rear portion of A-frame display assembly 40 is shown in FIG. 8. This view illustrates more clearly the essential features of this area of the printer cover device. A critical function of the paper guide assembly is protecting the printer from foreign objects that may enter through paper slot 30a and rear card removal slot 45a. Paper guide 31 extends up and over the paper slot to reject foreign objects from falling directly into the paper slot. The paper guide also deflects the receipt paper from the printer toward the cashier. Rear dam 32 protects the paper slot from foreign articles getting into the paper slot coming from base top 25. The rear dam also includes tear edge 32a that provides a sharp edge that can be used to tear off the receipt paper. There is also a potential for foreign objects to reach the printer through rear card removal slot 45a of protective cover 44. This slot has rear card ledge 45 to keep foreign objects from reaching the printer (see FIG. 6).

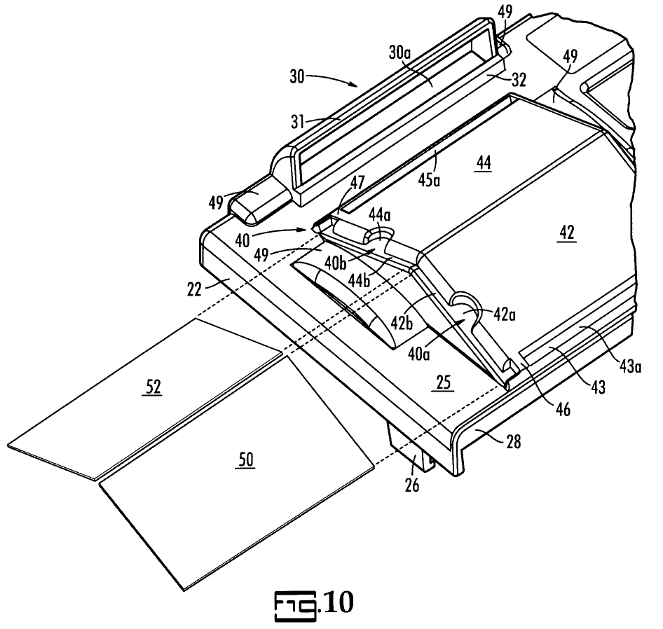

An enlarged view of the front portion of base 20 and the front portion of A-frame display assembly 40 is shown in FIG. 9. This view illustrates more clearly how front dam 28 protects the adjacent equipment (check endorser 4, see FIG. 1). Foreign objects falling on the base top 25 of base 20 are retained on the base top. The front dam also has a printer recess 20c that allows access to the means for opening the top of the printer to perform maintenance procedures. Once again, the printer cover stays on the printer when the printer is opened. There is also a potential for foreign objects to reach the printer through front card removal slot 43a of protective cover 42. This slot has rear card ledge 43 to keep foreign objects from reaching the printer (see FIG. 6).

The perspective view of FIG. 10 illustrates the message cards being positioned for entry into the A-frame display frame 40. As previously discussed, informational message card 50 is inserted in front card slot 40a to be displayed behind front protective cover 42. Promotional message card 52 is inserted in rear card slot 40b to be displayed behind rear protective cover 44. Removal of the instructional message card is realized by using front thumb slot 42a and front card removal slot 43a. Removal of the promotional message card is realized by using rear thumb slot 44a and rear card removal slot 45a. Card removal slots 43a and 45a are again shown. Four printer clearance portions 49 are also shown to provide clearance for protrusions on the top of the printer.

While a preferred embodiment of the invention has been described using specific terms, such description is for illustrative purposes only, and it is to be understood that changes and variations may be made without departing from the spirit or scope of the following claims.

What is claimed is:

1. A cover device for a point-of-sale receipt printer comprising:
a base having a retention mechanism to attach the cover device to the point-of-sale receipt printer;
a front dam of said base that helps prevent falling objects from being discharged from the top front area of the base into equipment adjacent to said printer;
a paper guide portion including a paper guide, a paper slot and a rear dam for allowing receipt paper to be discharged from the printer while protecting the printer from entry of foreign objects through said paper slot; and
an A-frame display portion having card slots to receive information cards stock with general promotional and information messages printed thereon.

2. The cover device of claim 1, wherein the retention mechanism of the base includes two side lips and a rear lip to grip three sides of the printer and conform to the external shape of the printer to provide a glove-like fit.

3. The cover device of claim 2, wherein said lips are formed with a negative draft angle to provide sufficient pressure on the printer to retain said base on the printer.

4. The cover device of claim 3, wherein the retention mechanism includes a latch extending from a bottom edge of one of said two side lips to engage a top of the printer and help hold said base attached to the printer.

5. The cover device of claim 1, wherein the retention mechanism includes double sided retention tape placed between the printer and a bottom side of said base.

6. The cover device of claim 1, wherein said base includes a pair of printer access button cutouts and a printer recess to provide unobstructed use of the operational and access areas of the printer.

7. The cover device of claim 1, wherein said base includes printer clearance portions to conform to a top surface of the printer.

8. The cover device of claim 1, wherein said base includes a logo area on a top surface of said base for a custom store logo or other message.

9. The cover device of claim 1 wherein said A-frame display portion includes:
front and rear protective covers to eliminate damage and provide easy removal of said card stock from said A-frame display portion;
a plurality of card removal slots to facilitate the removal of said information cards from said A-frame; and
a plurality of ledges to guide the insertion, support and removal of said card stock and reduce the potential for foreign objects to enter the printer through said slots.

10. A combination protective cover for a conventional point-of-sale printer to keep foreign objects from getting inside the printer system and general information display portion comprising:
a base having two side lips and a rear lip to grip three sides of the printer and conform to the exterior shape of the printer and provide a glove-like fit,
front and rear dams extending above the top surface of said base to keep foreign objects from falling into the printer system and adjacent equipment;
a paper slot with a paper guide above said slot to deflect the foreign objects from getting into the printer system while allowing receipt paper to be discharged from the printer; and
an A-frame display portion having card slots to receive information cards and including front and rear protective covers for said information cards.

11. The combination protective cover and display portion of claim 10, wherein said base further includes:
a pair of printer button access cutouts and a printer button recess to provide unobstructed use of the operational buttons and access recess of the printer system;
a printer clearance portion to allow said base to conform to a top surface of said printer; and
a latch extending from a bottom edge of one of said two side lips to engage a top of said printer and help hold said base attached to said printer.

12. The combination protective cover and display portion of claim 11, wherein a top surface of said base includes a logo area for a custom logo or other message.

13. The combination protective cover and display portion of claim 10, wherein said A-frame display portion includes:
a pair of card removal slots to facilitate the removal of said information cards from said card slots; and
a plurality of ledges to assist with the insertion, support and removal of said information cards and at the same time reduce the potential for foreign objects to enter the printer through said slots

14. The combination protective cover and display portion of claim 10, wherein said two side lips and said rear lip are formed with a negative draft angle to provide sufficient pressure on the printer to retain said base on the printer.

15. A method for protecting a point-of-sale printer and adjacent equipment from foreign objects getting inside and displaying general information comprising the steps of:
a) providing a base including a plurality of lips along the outer edge and a paper slot with a paper guide above said slot;
b) providing an A-frame display portion on the top side of said base including front and rear protective covers with card slots and a plurality of ledges;
c) forming front and rear dams above said base;
d) installing said base on the printer by positioning said lips to provide a glove-like fit on said printer;
e) protecting said printer from foreign objects by said dams and said paper guide keeping the objects from falling into the printer and adjacent equipment;
f) providing card stock for printing promotional and informational messages on business size cards;
g) inserting said card stock into said card slots of said A-frame display portion so that said ledges guide and retain said card stock under said protective cover;
h) providing thumb slots and card removal slots in said front and rear protective covers,
i) removing and replacing said card stock slots using said thumb slots and said card removal slots. and
j) opening the printer when needed to add paper or repair the printer without removing the protective cover from the printer.

16. The method of claim 15, wherein the step of installing said base on the printer further includes the steps of:
a) providing a latch attached to a bottom edge a side lip of said plurality of lips; and
b) connecting said latch to a side of the printer.
